(19) United States
(12) Patent Application Publication
(10) Pub. No.: US 2024/0124084 A1
(43) Pub. Date: Apr. 18, 2024

(54) Three-axis directional headlight control for motorcycle

(71) Applicant: Damon Motors Inc., Vancouver (CA)

(72) Inventors: Dominique Kwong, Coquitlam (CA); Julia Zhuravleva, Burnaby (CA)

(21) Appl. No.: 17/966,795

(22) Filed: Oct. 15, 2022

(51) Int. Cl. B62J 6/023; B62J 6/024; B62J 45/412; B62J 45/415

(52) U.S. Cl. CPC B62J 6/023; B62J 6/024; B62J 45/412; B62J 45/4151; B62J 45/4152

(57) ABSTRACT

Fixed-beam headlights reduce a rider's intended visual field by pointing away from a corner during turning. A system is presented for improving visibility in dark conditions on a motorcycle. It relates to adaptively controlling headlight orientation. Based on sensor data, the headlight beam is rotated independently in three degrees of freedom, in real time. This maintains illumination of the road ahead, even when cornering, and reduces the blinding of oncoming traffic. High beam and low beam operation is accommodated, including dimmable high beams. The beam is directed with three independent motors in one embodiment, by the switching of light-emitting diodes in an array in another embodiment, or using a hybrid motorized and solid-state system. The adaptive headlights are suitable for craft other than motorcycles.

### TECHNICAL FIELD

This invention relates to a system for improving visibility on a motorcycle. More specifically, it relates to the headlights and their orientation.

### BACKGROUND

Motorcycles by nature are an inherently dangerous mode of transportation, due to the direct exposure of riders to the environment and their vulnerability to surrounding traffic. Although many crashes are due to intersection collisions, there are other scenarios where the rider runs the risk of losing control of the motorcycle, such as during cornering. On a motorcycle, it is not as simple as turning a steering wheel, but rather the rider must use their whole body to countersteer and lean.

A critical technique of safe cornering is to always look where one wants to go. Therefore, it is crucial that the rider has full visibility of the road no matter the time of day. Motorcycles have fixed beam headlights, which point away from the corner during countersteering and results in a loss of visibility into the corner. In addition, the need to manually toggle the high beam (i.e. full beam or main beam) switch at night to prevent blinding oncoming traffic also draws the attention of the rider away from the road. At night, this poses a risk to rider safety.

Referring to FIG. 1, there is shown a traditional vehicle turning around a corner. A car 10 in the lower inner lane 14 is shown in three positions while travelling around a corner (turn) 18 toward the right. The light from the car's headlights forms an approximate “cone” 12, with the large outer top edge of the cone facing forward in the direction of travel and the inner lower part of the cone starting from the front edge of the car. It can be seen that the light cone 12 made by the car's headlights remains identical in all three positions while negotiating the turn 18. This is due to the car remaining approximately level with respect to the road. It can also be seen that the headlights do not penetrate the outer lane 16 of oncoming traffic 20 travelling around the corner 18 toward the left. It can be envisaged that weaker light from the headlights, if drawn with a longer light cone, may penetrate the lane 16 of outer oncoming traffic travelling around the corner 18. A weaker or peripheral part of the beam is not as hazardous as a stronger, more central part of the beam. A car's headlights are asymmetrically dipped on the left relative to the right in countries where one drives on the right. As a result, the oncoming car 20 typically does not experience any of the inner car's light cone 12 and is not blinded by its headlights.

Referring to FIG. 2, there is shown a traditional motorcycle 40 turning around a corner with a fixed beam headlight. Motorcycle 40 in the inner lane 44 is shown in five positions while travelling around a corner (turn, curve) 48 toward the right. In position one 54 and position five 62, before entering the turn 48 and after exiting the turn, the light from the motorcycle headlight forms a cone 42A, 42E similar to that of the car in FIG. 1, with the large outer top surface of the cone facing forward in the direction of travel and the inner bottom of the cone truncated before it forms a point. It can be seen that the light cone 42A, 42E made by the motorcycle headlight is identical in both position one 54 and position five 62 while traversing the turn 48, similar to the car in FIG. 1. This is due to the motorcycle being upright and perpendicular to the road before entering the turn and after exiting the turn. It can also be seen that the headlight beam does not penetrate the lane 46 of outer oncoming traffic travelling around the corner 48 toward the left in the direction of the arrow 50. As a result, the oncoming car 64 does not experience any of the motorcycle's light cone 42A, 42E and the driver of the oncoming car is not blinded by its headlight when it is in these positions.

However, a motorcycle 40 differs from a car in that it leans into a curve in order to turn around the corner 48. Position two 56, position three 58, and position four 60 demonstrate the difference in its experience on the road.

In position two 56 and position four 60, as the motorcycle 40 begins to lean to enter the turn 48 and as it begins to right itself again as it exits the turn respectively, the light from the motorcycle headlight forms a slightly malshaped cone of light 42B, 42D. In the incipient bank stage, the light cone 42B, 42D moves away from the curb at its right cone corner, toward the outside of the turn 48 as the right side of the motorcycle comes closer to the road. On the opposite, left corner of the misshapen light cone 42B, 42D toward the outside of the turn 48, the light cone 42B, 42D extends marginally over the center line 52 of the road and penetrates into the lane 46 of oncoming traffic as the left side points upwards. In short, the light cone 42B, 42D of the leaning motorcycle 40 is pulled and stretched toward the outside of the curve 48. In the banking of position two 56 and position four 60, the oncoming car 64 may experience some of the motorcycle's light cone 42B, 42D or light that extends beyond the light cone, and may be distracted by it.

In position three 58, as the motorcycle 40 fully leans into the turn 48, the light from the motorcycle headlight forms an even more misshapen cone of light 42C. In the fully leaning stage, the light cone 42C moves further away from the curb at its right corner and moves further toward the outside of the turn 48, as the right side distance from the motorcycle to the road diminishes even more. On the opposite corner of the misshapen light cone 42C toward the outside of the turn 48, the light cone 42C extends much more over the center line 52 of the road and penetrates extensively into the center of the lane 46 of oncoming traffic, as the motorcycle's left side points even more upwards. The light cone 42C of the fully leaning motorcycle 40 is pulled and stretched toward the outside of the curve 48 to its maximum distortion. As a result of the motorcycle headlamp light penetrating into more than half the oncoming car lane, the oncoming car 64 experiences enough of the motorcycle's light cone 42C for its driver to be potentially blinded by its headlight. The effect of a fully leaning motorcycle is to create an area of conflict 68 for the motorcycle 40 and car 64 while in a turn 48.

As a result of the lean, the traditional fixed beam headlight actually becomes directed toward the outside of the turn and in part upwards. This occurs both during low beam (i.e. dipped beam) and high beam operation. While intended to illuminate the road, the motorcycle light not only goes off course into the outer lane but also is pointed up into the oncoming windshields instead of toward the road surface.

In addition to potentially blinding drivers of oncoming traffic 64, in the fully leaning third position 58 the fixed beam motorcycle's light cone 42C is truncated in the forward direction where the motorcycle rider needs to see. Whereas the oncoming traffic on the outside of the curve experiences the motorcycle headlight directed up toward drivers' eyes, on the inside of the curve 48 the motorcycle headlamp beam is cut short by the ground to critically shorten the motorcycle rider's field of vision. When riding through corners, conventional motorcycle headlights do not adequately illuminate the intended path or direction of travel in the dark. The same applies whether the headlight is mounted on the body or the handlebars of the motorcycle.

This background is not intended, nor should be construed, to constitute prior art against the present invention.

### SUMMARY OF THE INVENTION

The present invention relates to a system for improving visibility on a motorcycle. The invention has elements in the headlights which facilitate their use. The inventors have realized a headlight technology that can orient the headlights as necessary toward the rider's visual field, while not blinding oncoming motorists. The principle of this invention is to utilize the headlights as an active, adaptive component. Instead of being passively situated, they react to the leaning, pitching and yaw conditions of the motorcycle and conform to the visibility requirements encountered by the rider as a result. This is different from conventional headlight performance limitations.

When riding through corners, the headlight mechanism responds to input from its various sensors and directs the light path to the intended direction of travel. The headlight rotates around the z (vertical) axis to point in the direction of the corner. It also rotates around the y (fore-aft horizontal) axis to level the shaped light beam with the horizon, which prevents the ground from truncating the light during the lean. This procedure returns the motorcycle light cone to its non-leaning illumination capacity, thereby reducing the risk created by fixed beam headlight blackout areas.

By rotating the headlight around the y axis to level the headlight beam shape with the horizon, the system additionally removes the area of conflict with oncoming traffic, which may otherwise be experienced during turns. During low beam operation, rotating the headlight around the y axis is sufficient to restore the light cone to an orientation where it is equivalent to that of a car, even while cornering. During high beam operation, in addition to y axis rotation, the light also momentarily rotates down around the x (transverse horizontal) axis to stop blinding oncoming traffic. Creating a hazard for other traffic impacts the safety of other vehicles on the road as well as for the motorcycle, which by its open structure is particularly vulnerable should it become a target in a collision.

The pitching effect imposed on the headlight beam while the motorcycle is accelerating, decelerating and traversing steep inclines is counteracted through rotation of the headlight around the x axis. The headlight mechanism keeps the beam pointed straight ahead and on the road ahead instead of illuminating just the nearby ground or pointing upwards, potentially blinding oncoming traffic. Thus the danger that night riding would pose of the high beam illuminating or tilting up into the visual field of other drivers is also averted. Headlight tilting due to acceleration, deceleration and traversing steep inclines is a common operational issue resolved with the adaptive headlights disclosed herein, in addition to remedying the visual problems encountered while cornering.

For sudden acceleration or braking, the headlight is rotated fast enough to maintain a level beam, particularly when the control system is optimized. The requirement is not far different from optimizing instantaneous throttle response, which has also been proven effective. Small rotations of the headlight mechanism results in large displacements of the illumination path, and, since only small movements are needed, any lag has minimal effect. The decision to move the motors takes less than a few milliseconds, for example, and the time needed to move the headlight itself is in the range of 0.1 to 0.5 seconds, for example.

To further decrease the lag time in some embodiments, the control system anticipates pitch changes as a result of acceleration and deceleration by taking input from the throttle position and brake pressure sensors, rather than input from the wheel speed sensor or an IMU (inertial measurement unit). The reason for this is that the motorcycle's reaction to the throttle or brake input, exhibited by its wheel speed, usually has some lag.

In addition to automatically rotating the headlight around the x axis to avoid blinding traffic, the headlight microcontroller alternatively takes inputs from an ambient light sensor to automatically turn the high beams on and off depending on the amount of light outside. The rider is not required to manually toggle the switch to stop the high beam from blinding oncoming traffic as it is a distracting convention, diverting the rider's attention from the road. To assist in rider safety, the setting of the high beam is controlled by the headlight mechanism.

Disclosed is a headlight system for a vehicle comprising: a light source that produces a light beam; one or more sensors that detect an orientation of the vehicle in three dimensions and a motion of the vehicle in the three dimensions; and a controller that uses the orientation and the motion to adjust a direction of the light beam about three orthogonal axes relative to the vehicle so that a path of the vehicle in the three dimensions is illuminated.

Also disclosed is a motorcycle having a headlight system comprising: a light source that produces a light beam; one or more sensors that detect an orientation of the motorcycle in three dimensions and a motion of the motorcycle in the three dimensions; and a controller that uses the orientation and the motion to adjust a direction of the light beam about three orthogonal axes relative to the motorcycle so that a path of the motorcycle in the three dimensions is illuminated.

Further disclosed is a method of controlling a headlight of a vehicle comprising: producing a light beam with the headlight; detecting, using one or more sensors, an orientation of the vehicle in three dimensions; detecting, using the one or more sensors, a motion of the vehicle in the three dimensions; and adjusting, by a controller that uses the orientation and the motion, a direction of the light beam about three orthogonal axes relative to the vehicle so that a path of the vehicle in the three dimensions is illuminated.

### BRIEF DESCRIPTION OF THE DRAWINGS

The following drawings illustrate embodiments of the invention, which should not be construed as restricting the scope of the invention in any way.

FIG. 1 is a schematic drawing of a traditional 4-wheeled vehicle on a corner.

FIG. 2 is a schematic drawing of a traditional motorcycle on a corner.

FIG. 3 is a graph depicting the corrective headlight pitch angle of a motorcycle, according to an embodiment of the present invention.

FIG. 4 is a schematic drawing of a view of the coordinate system of the motorcycle, according to an embodiment of the present invention.

FIG. 5 is a schematic drawing of a view of the coordinate system of the motorcycle during a lean, according to an embodiment of the present invention.

FIG. 6 is a flowchart of the steps to control a motorcycle headlight, according to an embodiment of the present invention.

FIG. 7 is a block diagram of a motorcycle with an adaptable headlight, according to an embodiment of the present invention.

FIG. 8 is a schematic drawing of a direction control mechanism for a headlight, according to an embodiment of the present invention.

FIG. 9 is a graph of the adaptive headlight directional range, according to an embodiment of the present invention.

FIG. 10 is a schematic drawing of the adaptive headlight cone for an upright motorcycle, according to an embodiment of the present invention.

FIG. 11 is a schematic drawing of the adaptive headlight cone for a cornering motorcycle, according to an embodiment of the present invention.

FIG. 12 is a graph of the high beam function, according to an embodiment of the present invention.

FIG. 13 is another graph of the high beam function, according to an embodiment of the present invention.

FIG. 14 is schematic of a stationary adaptive headlight for a car that uses a matrix of light-emitting diodes.

FIG. 15 is schematic of a stationary adaptive headlight for a motorcycle that uses a larger matrix of light-emitting diodes, according to an embodiment of the present invention.

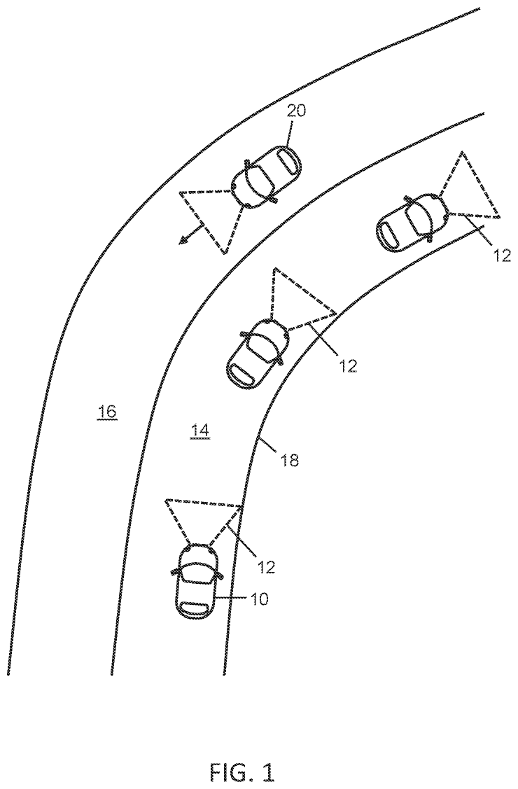

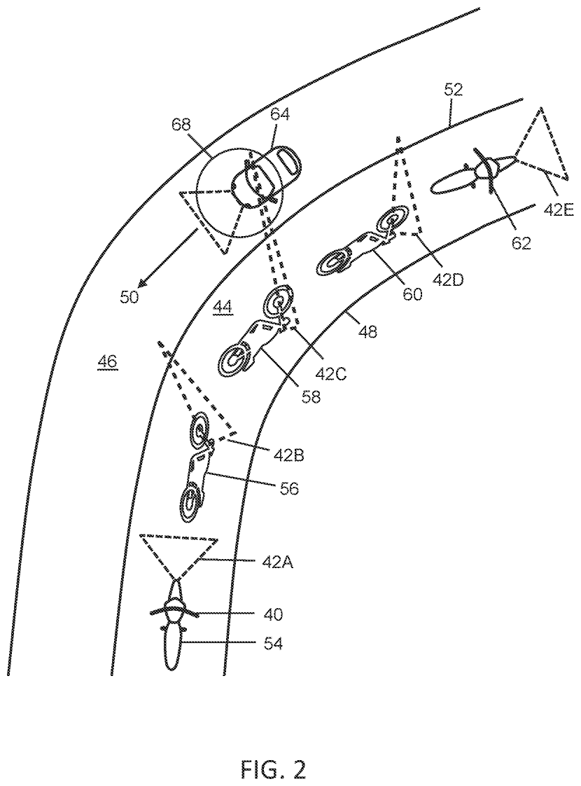

### DETAILED DESCRIPTION

### A. Glossary

DOF— Degrees of freedom

Fairing—an external structure added to increase streamlining and reduce drag, especially on a high-performance motorcycle. A fairing could be metal, plastic, carbon fiber or any other suitable material.

The term “firmware” includes, but is not limited to, program code and data used to control and manage the interactions between the various modules of the system, or to perform some or all of the control of the headlight.

The term “hardware” includes, but is not limited to, the physical housing for a computer or controller, components of a headlight, a headlight control mechanism or other components of a motorcycle.

IMU—inertial measurement unit. The IMU is a sensor that measures triaxial linear acceleration and triaxial angular velocity. The IMU consists of an accelerometer, which can output linear acceleration signals on three axes in space, and a gyroscope, which can output angular velocity signals on three axes in space.

LED— Light-emitting diode, which may include a diode laser.

The term “module” can refer to any component in this invention and to any or all of the features of the invention without limitation. A module may be a software, firmware or hardware module, and may be located in the headlight system or elsewhere in the motorcycle.

The term “processor” or “microcontroller” or “microprocessor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs, for example, the steps in the flowchart, whether they are explicitly described as being executed by the processor or whether the execution thereby is implicit due to the steps being described as performed by code or a module. The processor, if comprised of multiple processors, may be located together or separate from each other.

The term “software” includes, but is not limited to, program code that performs the computations necessary for determining, for example, the direction in which the motorcycle is pointing, the direction in which the motorcycle is moving, the predicted or expected path of the motorcycle, whether there is oncoming traffic, whether the oncoming traffic may be blinded by the motorcycle's headlight, and adjustments to the pointing direction of the headlight relative to the motorcycle in three orthogonal directions.

The term “real-time” means that as one action is occurring, another action is occurring in response to it and at the same time, subject to inherent time lags due to electronic and mechanical limitations. The actions may appear to a human to be simultaneous, or to be close enough together that their occurrences are, for substantially all intents and purposes, as good as simultaneous.

The term “system” when used herein refers to a system for controlling a pointing direction of a vehicle's headlight, the system being the subject of the present invention.

### B. Exemplary Embodiments

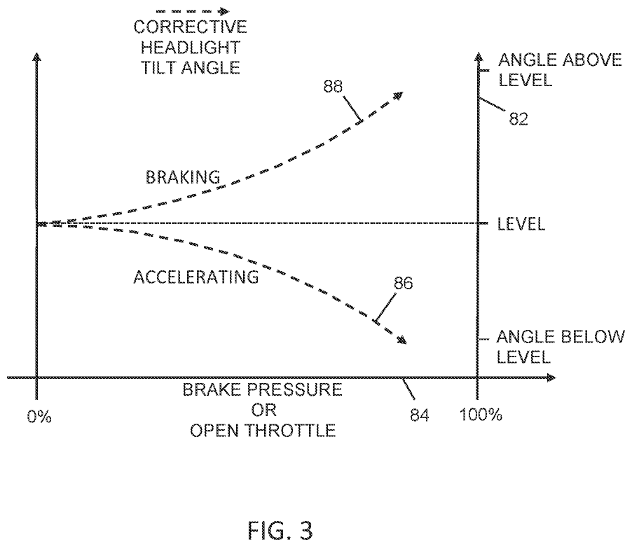

Headlight tilt also relates to acceleration and deceleration and is not limited merely to cornering. As a motorcycle accelerates, the attitude or pitch of the motorcycle will point upward, hence the need to have the headlights adjusted downward towards the ground in order to illuminate it. For braking, due to the angle of the motorcycle, the headlight would normally be directed to illuminate a small portion of the road ahead. However, a headlight tilt compensation is applied to illuminate more of the road ahead. Referring to FIG. 3, there is shown a graph depicting the corrective headlight pitch angle during changes in speed. The graph displays a schematic relationship between opening the throttle or applying brake pressure on axis 84, resulting in an amount of corrective headlight tilt 86, 88 respectively and its direction 82. The application of the throttle or brake is displayed as a percentage on the horizontal axis 84, and the corrective headlight tilt 86, 88 is displayed as the angle below or above level on vertical axis 82. With zero application of the throttle or brake there is no acceleration or deceleration, and thus no headlight pitching. On level ground, the tilt of the headlight is zero, i.e. it is at its default, level position. As the throttle is opened and the motorcycle accelerates, the motorcycle experiences an opposing reaction to the positive change in velocity, its center of gravity shifts rearward, and the front of the motorcycle pitches up. To stop the headlight pitching up, a downward tilt on curve 86 is applied. The tilt applied is relative to the fore-aft axis of the motorcycle, which is level when the motorcycle is on level ground.

Conversely, as brake pressure is applied and the motorcycle decelerates, the motorcycle experiences an opposing reaction to the negative change in velocity, its center of gravity shifts forward, and the front of the motorcycle pitches down. To stop the headlight from pitching down, a corrective tilt upward on curve 88 is applied to the headlight.

The relationship between brake pressure, open throttle, positive acceleration, or deceleration shown in the graph may be non-linear or linear.

When fixed beam headlights point up or down during acceleration and deceleration respectively, pulling the light away from the level forward position, it reduces the illumination of the road ahead. Additionally, fixed beam headlights point up or down relative to the road surface when the bike is ascending and descending steep inclines, respectively, even at constant speed. This poses visual difficulties for the rider driving at night if the road ahead suddenly blacks out. Consider, for example, the potential consequences of a rider executing a rapid deceleration who loses sight of the hazard that they are braking for. During acceleration or ascending a steep incline, without turning, headlamps pointed up into oncoming car windshields may blind oncoming traffic as well, posing a risk to those other vehicles sharing the road. Not only does that compromise the safety of other drivers, but that danger can also rebound back onto the motorcycle rider as oncoming drivers loses sight of their own lane when passing a motorbike. The system therefore takes into account the slope of the road that the motorcycle is traveling on as well as the acceleration and deceleration. For example, when the acceleration or deceleration is zero and the motorcycle is traveling at constant speed on a slope, a corrective tilt angle may still be applied to the headlight, which increases in magnitude as the angle of the slope increases.

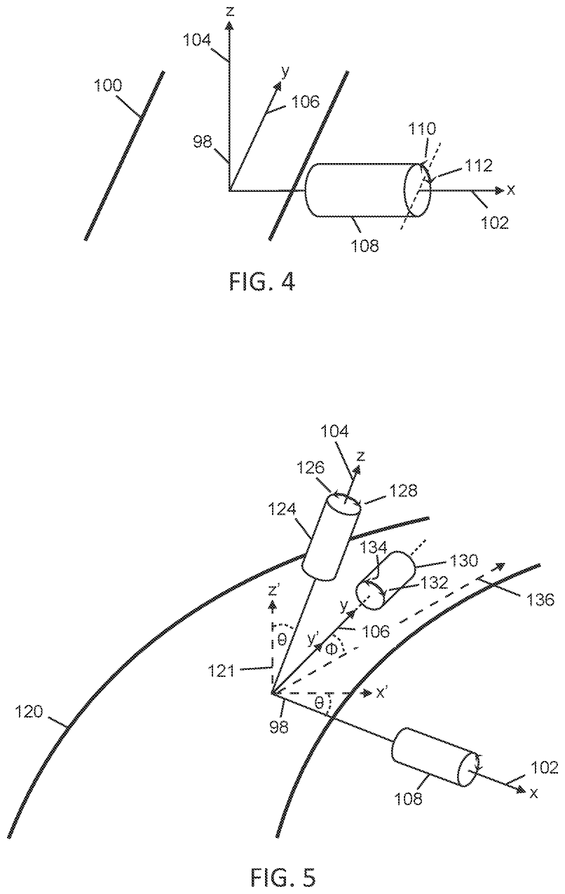

Referring to FIG. 4, there is shown a schematic drawing of a view of the coordinate system 98 of the motorcycle while erect. It demonstrates the (x, y, z) frame of reference of the motorcycle, for example while riding straight down a level road 100. The x axis 102 is horizontal and lateral to the motorcycle. The z axis 104 is vertical in line with the upright motorcycle. The y axis 106 goes straight down the road 100.

By imposing a cylinder around any of the axes, here showing the cylinder 108 along the x axis 102, rotation about the axis is shown. Normally, the rotation about the x axis 102 may result in any movement in a 360 degree direction about the axis, but the headlight system is primarily concerned with a relatively small up movement 110 and down movement 112 about the x axis.

When the motorcycle pitches up or down during acceleration, deceleration or traversing steep inclines, the headlight mechanism prevents the headlight beam from tilting up or down respectively. The system counteracts the bike's natural pitching reactions to changes in velocity by rotating the headlight about the x axis 102 to properly illuminate the road. When the motorcycle accelerates or ascends a steep hill and the headlight as a whole tilts upward with the bike or away from the road, the mechanism independently rotates the headlight beam about the x axis 102 so it countertilts downward with movement 112. When the motorcycle decelerates or descends a steep hill and the headlight as a whole tilts downward with the bike, the headlight mechanism independently rotates the headlight beam about the x axis 102 so it countertilts upward with movement 110. The result is that the headlight beam is kept pointed straight ahead in real time, generally level with the road instead of illuminating too much of the near ground or aiming upward to blind oncoming traffic. This is true even on a slope. Thus the danger that night riding would pose of the beam tilting up into the visual field of other drivers is averted with the system's adaptive headlight.

Referring to FIG. 5, there is shown a schematic drawing of a view of the coordinate system 98 of the motorcycle during a lean. It demonstrates (x, y, z) coordinates in the frame of reference of the motorcycle while leaning in a curve 120 of a road. Compared to what would be the erect (x′, y′, z′) coordinates or world coordinates 121, the motorcycle's coordinates (x, y, z) are rotated around the γ′ axis by angle θ. The y′ axis is shown identical to y axis 106, however, they are not necessarily identical to each other as the motorcycle may experience yaw (relative to the instantaneous direction of motion) as it negotiates the turn. As before, the x axis 102 is lateral to the motorcycle even though it is leaning down to the right, to the inside of the curve 120. The z axis 104 also tilts with the motorcycle as it leans into the curve 120. The y axis 106 remains pointing in the direction of the motorcycle as it moves along the road, in this example. Note that the world frame of reference shown by coordinates 121 is arbitrary and can be chosen depending on how the calculations are performed. It may be static, or it may move and rotate with the motorcycle's instantaneous direction of travel, so that the γ′ axis is aligned with the direction of the horizontal component of the motion of the motorcycle. Irrespectively of how the coordinate systems are chosen, the requirement is that the orientation and the motion of the motorcycle are determined in three dimensions.

By imposing a cylinder around any of the axes, here showing the cylinder 108 along the x axis 102, rotation about the axis is shown. Similarly, by imposing a cylinder 124 along the z axis 104, rotation about the z axis is shown. The rotation about the z axis 104 may again result in any movement in a 360 degree direction about the axis, but the headlight system primarily is concerned with relatively smaller the side-to-side movement about the z axis, specifically to the left 126 and right 128. By imposing a cylinder 130 along the y axis 106, rotation about the y axis is shown. The headlight system primarily is concerned with relatively smaller movement about the y axis, specifically clockwise 132 and counterclockwise 134.

The system counteracts the bike's three-dimensional (3D) reaction during cornering to properly illuminate the intended direction of travel. When the motorcycle turns around a curve 120, to stop the headlight pointing toward the outside of the curve, the mechanism independently rotates the headlight about the z axis 104 so that it counterpoints inward 128 and not into oncoming traffic. As a result, the center direction of the headlight beam may be to the right of the y axis by an angle Φ, in direction 136 for example, to illuminate the expected path of the motorcycle based on its current orientation and motion. The radius of curvature of the road or lane may be deduced or predicted from the yaw rate of the motorcycle and its speed or velocity, obtained for example from the IMU. It is possible that the same lean of the motorcycle may be used for negotiating curves of different radii of curvature, at different speeds. If more throttle is applied (i.e. acceleration) the motorcycle at a fixed lean angle will push wide or drive in a greater arc, the opposite being true under deceleration. As such, the adjustment for the lean is independent of the adjustment for travel direction.

When the motorcycle turns around a curve 120, to stop the headlight beam being truncated toward the inner edge of the curve, the mechanism independently rotates the headlight counterclockwise 134 about the y axis 106 so that the beam is maintained level. This procedure returns the motorcycle light cone to its non-leaning illumination capacity and aims it in the direction of the motion, thereby reducing the risk created by fixed beam headlight blackout areas. The system takes into account vehicle lean angle (using an inertial measurement unit) and speed (using wheel speed sensor) in order to allow the headlight adjustment mechanism to compensate for changes in the orientation and motion of the motorcycle relative to the road. Ultimately, the system provides improved consistency of lighting of the road surface regardless of the lean angle, speed and pitch of the motorcycle, the pitch of the motorcycle being measured relative to the surface of the road in the case of inclines and declines.

During low beam operation, counter-rotating the headlight around the y axis 106 is sufficient to restore a desirably illuminating light cone. During high beam operation under a dim ambient light setting, in addition to y axis rotation, the high beam is switched to low beam when there is oncoming traffic. Alternately, during high beam operation under a dim ambient light setting, the light is also momentarily counter-rotated downward around the x axis 102 to stop blinding oncoming traffic.

The result, again, is that the beam is kept pointing toward the road ahead instead of pointing upward and blinding oncoming traffic. Thus the danger that night riding would pose of the high beam tilting up into the visual field of other drivers is also averted with the system's adaptive headlight. Even when the motorcycle is on a straight road, the high beam is momentarily dipped when oncoming traffic is detected and the ambient light is dim enough to blind oncoming traffic.

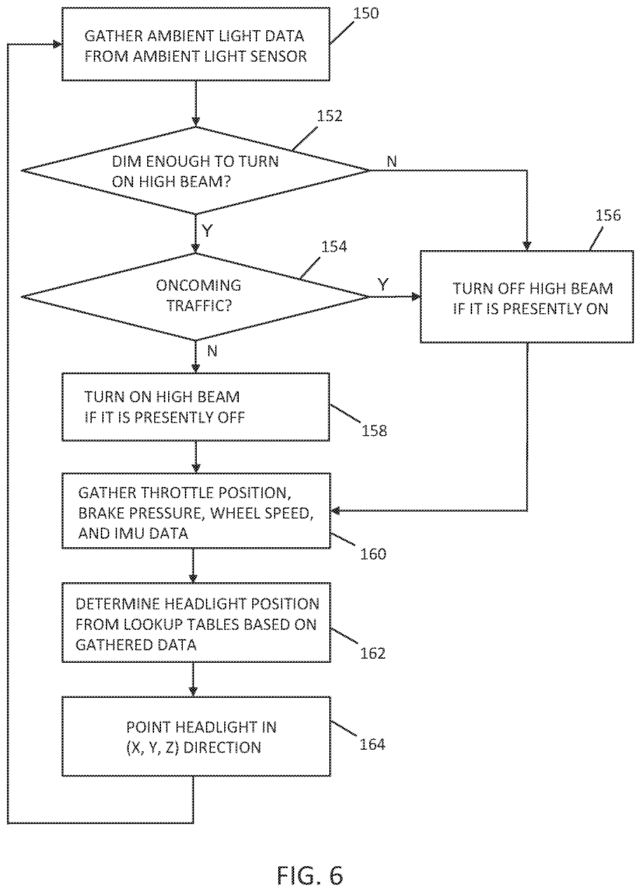

Referring to FIG. 6, there is shown a flowchart of the steps to aim the headlight in an exemplary embodiment of the system. There may be a prescribed order for the sequence of events to aim the headlight, according to the particular system. This specific embodiment has a headlight with automatic, digital on/off high beam control, and the ability to rotate and point to a specified direction with the use of a three degree of freedom (DOF) mechanism. The rotation or beam redirection occurs in the following cases: (1) the rider goes into a corner, and/or (2) the high beams are on and there is oncoming traffic and the ambient light conditions are dim enough that the high beams are blinding, and/or (3) the rider is accelerating or decelerating and/or the motorcycle is on an incline.

Step 150 of the flowchart for the control of the adaptive headlights is to gather ambient light data from the ambient light sensor or sensors. The sensors are positioned so as to collect data which comes from general riding conditions, such as daylight versus night, bright streetlights versus dark tunnels or dim stormy days. It takes into account the overall light present in the motorcycle's environment as opposed to one-off uneven or sporadic sources.

Step 152 is a Boolean function determining whether the amount of ambient light is dim enough to turn on the high beam. The sensor data is compared with a lightness threshold. If the ambient light is low enough the programming moves to step 154, and if high enough it moves to step 156. This step 152 is a juncture branching off in YES 154 and NO 156 directions.

In step 154, the system ascertains whether there is oncoming traffic. If not, the programming proceeds to the next step. If oncoming traffic is in the vicinity, then in step 156 the high beam is turned off if it is presently on. Dim or minimal ambient light is more prone to cause flash blindness because of the contrast between the darkness and the intense high beam glare, considering the driver's pupil dilation at night. In contrast, high beams have relatively little effect on oncoming motorists in bright sunlight.

Steps 158 and step 156 toggle the high beam on or off respectively. First the present status of the high beam is probed to ascertain whether it is currently off or on. If it is dim enough to merit turning on the high beam, and if it is presently off, then the high beam is switched on in step 158. If it is dim enough to turn on the high beam and it is already on, then it is not toggled. It remains on.

In step 156, the present status of the high beam first is probed to ascertain whether it is currently off or on. If it is not dim enough to merit turning on the high beam, and if it is presently on, then the high beam is switched off in step 156. If it is not dim enough to turn on the high beam and it is already off, then it is not toggled. It remains off. Automatic toggling of the high beams saves the rider from additional distractions and operations to perform during relatively critical maneuvers, such as leaning in a corner while passing oncoming motorists in dimly lit conditions.

Step 160 of the system is to gather throttle position, brake pressure, wheel speed, and IMU motion and angle data from the sensors. The throttle, brake pressure, and wheel speed correspond with acceleration and deceleration and the required corrective pitch angle of the headlights. The IMU accelerometer and gyroscope measurements duplicate the acceleration and deceleration information leading to headlight tilting, and these are the sensors also responsible for providing the three dimensional data pertaining to the orientation of the motorcycle during a curve. The IMU detects whether the motorcycle is traveling on a slope, and the angle or gradient of the slope. The orientation data includes the roll (lean), the pitch and the yaw of the motorcycle. In some embodiments, the slope of the road and the pitch angle of the motorcycle relative to the angle of the road is taken into account when determining the direction in which to aim the headlight.

Depending on the embodiment and the default illumination pattern of the headlight, the lean data may or may not be treated differently for a motorcycle taking the inside lane in a curve compared to one taking the outside lane of the curve. The skyward edge of the rider's light cone is directed toward the outside of the curve where there is no opposing traffic, and there is no conflict in that respect. A motorcycle rider in the outside lane of a curve experiences only the similar truncated field of vision they would experience when leaning in the inner lane of a curve. However, the default illumination pattern of the headlight may spill into the inner, oncoming lane as the motorcycle goes around the outer lane of a curve and in these situations the headlight beam is adjusted if necessary to reduce the blinding effect on the drivers of oncoming vehicles.

An alternative to the IMU is to use a camera to detect the motorcycle's dynamic state. It measures the pitch angle in relation to the horizon or road during acceleration and deceleration and the lean angle in relation to the horizon during cornering by forwarding the image feed to an image processing module.

Step 160 then feeds into the program of step 162 to determine the setting for the headlight direction from lookup tables, for example, based on gathered data. The issue of blinding oncoming traffic involves the direction of the headlight being cast into the outside lane and the high beam being toggled on. On the inside of the turn the rider needs adequate visibility of the road where the lower end of the headlight beam is truncated. Even should there be no oncoming traffic and no flash blindness, general road visibility is still in question if the light cone wanders and distorts, as it does while changing speed and leaning around a curve. From the acceleration and lean data the system is able to determine the triaxial orientation or setting for the light cone relative to the coordinate frame of the motorcycle, based on the orientation and motion of the motorcycle in the world frame of reference.

Step 164 addresses the visibility issues created by the motorcycle for both the rider and oncoming traffic, and the microcontroller remedies the deficiencies by directing the headlights as needed. In a curve, the x and z axes tilt at an identical angle, following the lean of the motorcycle, as the (x, y, z) frame of reference rotates around the y axis. That tilt represents the leaning frame of reference of the motorcycle before the microcontroller compensates, and performs the mechanical headlight correction in step 164 by counter-rotating along any or all of the three axes according to their specific individual requirements. The headlight is pointed in the desired direction by three aiming motors, one for each axis.

Furthermore, the microcontroller monitors the outputs from the IMU and wheel speed sensors with a frequency sufficient to ensure optimal lighting is achieved in a smooth manner, and may adapt to a rapidly dynamic environment such as high speed cornering and oncoming traffic.

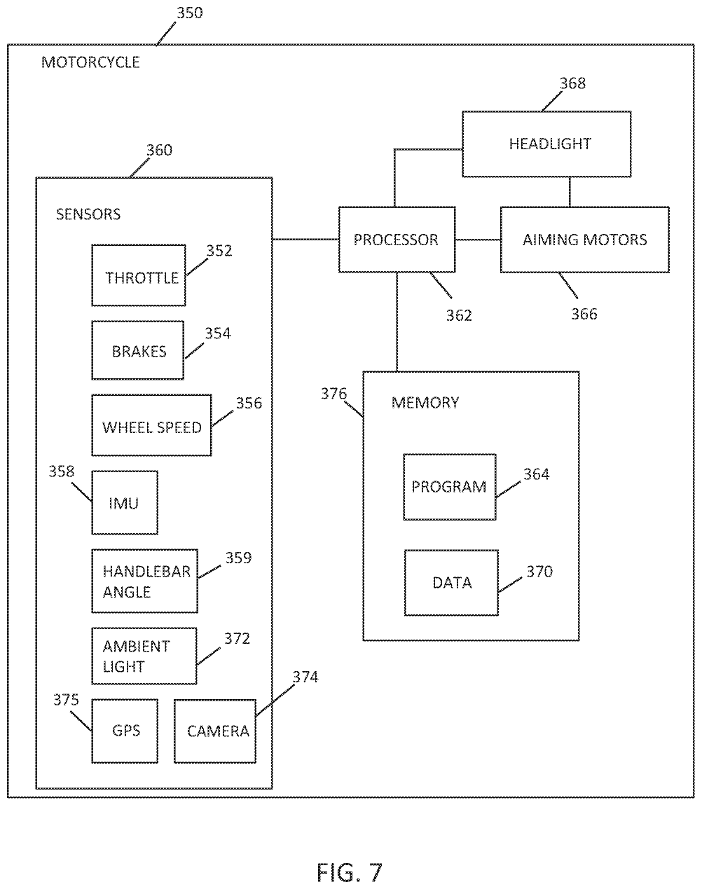

Referring to FIG. 7, there is shown a block diagram of various modules of the headlight control system in a motorcycle. The motorcycle 350 has a processor 362, which collects sensor information from sensors 360. The sensors include, for example, a throttle position sensor 352, a brake pressure sensor 354, a wheel speed sensor 356, an IMU 358, an optional handlebar angle sensor 359, an optional camera 374, an ambient light sensor 372 and an optional GPS sensor 375.

The ambient light sensor 372 collects data on the environmental light level. The wheel speed sensor 356 and IMU 358 collect data on the velocity, acceleration and triaxial angular displacement of the motorcycle. One mode of this system is to use an IMU and wheel speed sensor to detect the motorcycle's triaxial acceleration, lean angle, and wheel speed. The information feeds into the processor 362, which is coded by a program 364 to output a specific desired light beam direction. The processor 362 collects the sensor data, then processes what it means, determining the headlight direction. It then outputs a signal to the motors to point the headlight in the desired direction in the (x, y, z) frame of reference, i.e. in a direction relative to the frame of reference of the motorcycle.

Based on the gathered data from the sensors, the processor 362 determines the motorcycle's current situational orientation and motion. The current situational orientation and motion include, for example, an angle of lean, a speed, a curvature of the motorcycle's trajectory, a gradient of the trajectory, an angle of the handlebars relative to the body of the motorcycle, a pitch angle of the motorcycle and a yaw of the motorcycle. The motorcycle 350 then uses the program 364 stored in the memory 376 in conjunction with data 370 to determine the required settings for the headlight orientation from lookup tables in the data, so that aiming motors 366 can control triaxially moveable headlight 368 to compensate for inherent visibility limitations.

The program 364 includes computer readable instructions stored in computer-readable memory 376, which when executed by the processor 362, cause a direction of the motorcycle headlight 368 to be adjusted. The program 364 may access and use the computer-readable data 370 also stored in the computer readable memory 376. In some embodiments, the data 370 may include a map, and the sensors may include a GPS sensor 375 or other location-sensing detector to determine the location of the motorcycle on the map. The curvature of the road on the map at the location of the motorcycle may be taken into account in determining the instantaneous and projected trajectory of the motorcycle as it negotiates a curve. Each of the three aiming motors 366 responds to a driver, which is part of the program 364, resulting in 3-DOF directional control of the headlight. The processor 362 and memory 376 may form a module within the motorcycle, or may be part of an electronic control unit (ECU) of the motorcycle.

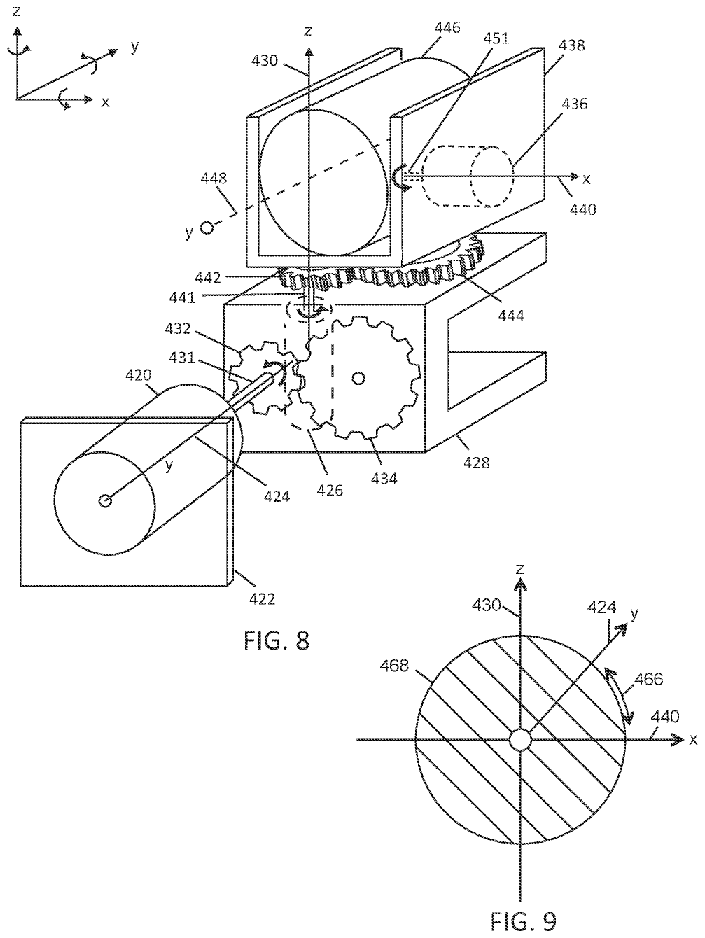

Referring to FIG. 8, which is not to scale, there is a schematic drawing illustrating the principle of the direction control mechanism for the headlight 446, the view of the headlight being from the rear. The illustration depicts the mechanism whereby the processor is able to physically manipulate the headlight orientation in the three dimensions (x, y, z) of the frame of reference of the motorcycle in real time. The mechanism includes three DC (direct current) motors to control rotation around the x, y and z directions, as shown in the illustration. As depicted in the inset, the x axis is lateral to the motorcycle, the y axis is in the forward direction of the motorcycle, and the z axis is in the vertical direction of the motorcycle.

The mechanism includes motor 420 mounted to a fixture on a platform 422. The motor 420 rotates around the y axis 424 and has a spindle 431 attached which extends from the motor to the smaller gear 432 of a reduction gear set 432, 434. The smaller gear 432 drives the larger gear 434 of the set. The larger gear 434 is directly attached to a second platform 428 and rotates the second platform around the y axis 424 with the power of motor 420.

The second platform 428 holds a second motor 426 which rotates around the z axis 430 and has a spindle 441 attached which extends from the motor 426 along the z axis, to the smaller gear 442 of another reduction gear set 442, 444. The smaller gear 442 drives the larger gear 444 of the set. The larger gear 444 is attached to a third platform 438 and rotates the platform around the z axis 430 with the power of motor 426.

Lastly, the third platform 438 supports a third motor 436, which tilts the headlight 446 via spindle 451 aligned with the x axis 440. The headlight points in the y direction 448 in its central or unadjusted state. The third motor 436 drives the headlight 446 through a reduction gear set (not shown), allowing the headlight 446 to rotate around the x axis 440.

For the rotating mechanisms, the order of the axes and platforms can, in other embodiments, differ from the high-level example shown. In general, it is best practice to minimize the moment of inertia to allow for a quicker rotating response time, by keeping the platforms as compact as possible. In some embodiments, the relative proportions of the platforms, motors and gears are different, and are differently positioned, and the axes of the motors are differently positioned. The main requirement is that the headlight can be rotated about three orthogonal axes, independently about each axis.

Referring to FIG. 9, there is shown a graph of the range of pointing directions of the headlight relative to the motorcycle. The headlight beam may point to any coordinate in the x, z cartesian grid shown by the hatched circle. The illustration shows the result of the three degrees of freedom of the mechanism. The combination of two independent platforms and three motors allows for simultaneous or independent rotation around the x, y and z axes (or directions parallel to these). The x axis 440 represents the lateral direction, left and right. The headlight can be pointed left or right relative to the center point by rotating the headlight about the z axis 430. Also, to a certain extent, particularly if the illumination cone of the headlight is asymmetrical, the average light distribution from the headlight can be shifted to the left or right by rotation of the headlight about the y axis 424.

The z axis 430 represents the vertical axis, up and down. The headlight may be pointed up or down by rotation of the headlight about the x axis 440. Also, to a certain extent, particularly if the illumination cone of the headlight is asymmetrical, the average light distribution from the headlight can be shifted up or down by rotation of the headlight about the y axis 424.

The y axis 424 represents the fore-aft axis of the motorcycle, which is usually but not necessarily aligned with the direction of travel, particularly on a straight road. The boundaries of the hatched circle 468 may be defined by the physical space or design constraints of the headlight mechanisms. However, in some embodiments, the circle may be replaced with a square or a rectangle or other shape. To exemplify rotation of the headlight beam about the y direction 424, the bi-directional arrow 466 shows that the circle 468 can be rotated about the y axis in the third degree of freedom. The headlight can also rotate around the y axis to be level with the horizon at any lean angle.

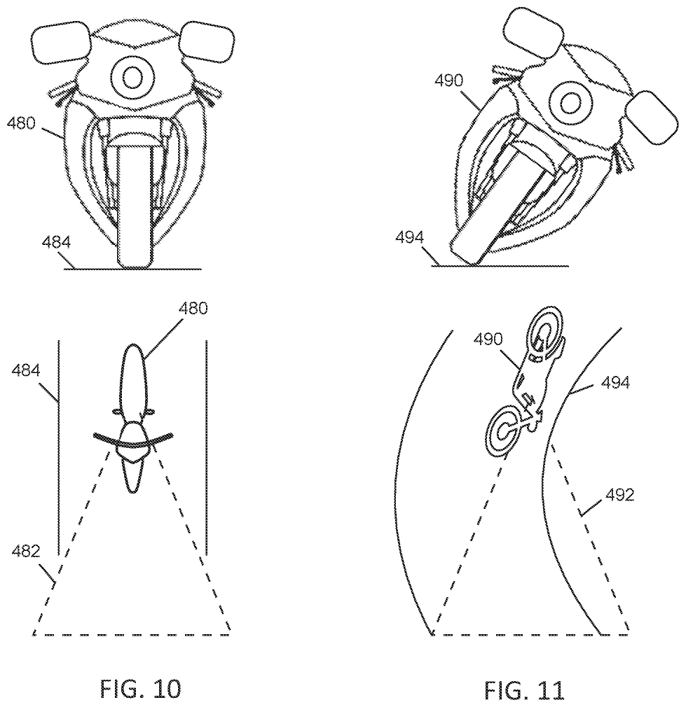

Referring to FIGS. 10 and 11, there are shown schematic drawings of the adaptive headlight orientation. The erect motorcycle 480 shows the light cone 482 obtained when riding down a straight road 484. Following correct adjustment of the headlight orientation, the leaning motorcycle 490 is able to illuminate a curved road 494 when leaning at an angle, just as the erect motorcycle 480 illuminates the road 484 straight ahead. With the moving headlight, a leaning motorcycle 490 riding down a curved road 494 achieves the desired light cone 492 after mechanical reorientation. The truncation occurring on the leaning side of the visual field, as a result of fixed positioning on a leaning object, is resolved as the headlight adapts.

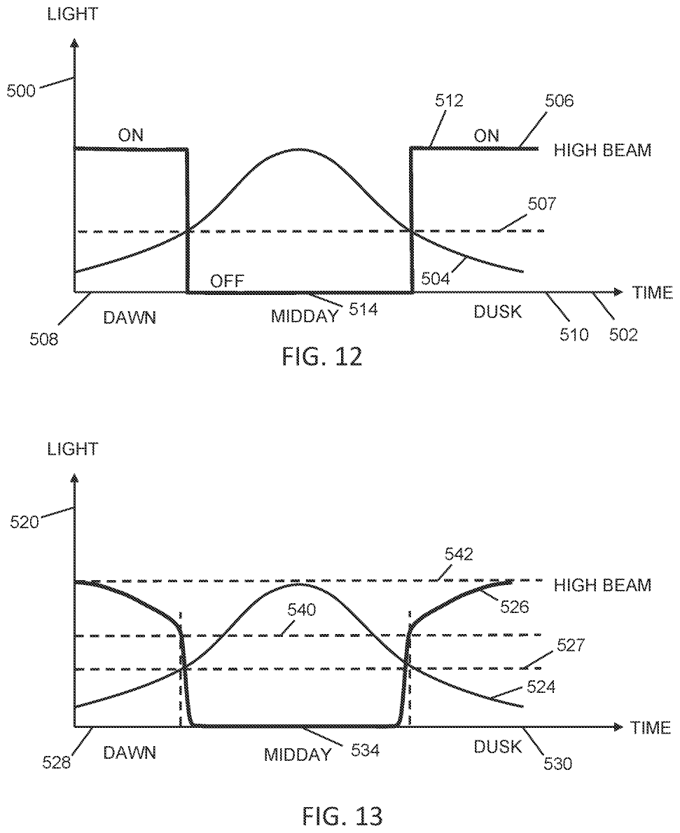

Referring to FIG. 12, there is shown a graph of the high beam function as a function of ambient light 500. The system detects the amount of light outside through the ambient light sensor. The data from the sensor feeds into a processor or microcontroller, which turns the high beams on or off automatically, based on the amount of light outside. This saves the rider from the additional distraction of toggling while cornering, for example. The rider is potentially already contending with environmental darkness and the contrast of a headlight-illuminated compacted visual field, acceleration possibly coupled with cornering, as well as opposing traffic.

A typical example of the high beam operation 506 throughout the day can be seen. The graph line 504 is an approximation of the level of atmospheric light based on the time of day 502, from dawn 508 to dusk 510. However, the real operation of the system is not preset by time of day, rather it is fluid, depending on the actual light detected by ambient light sensors at a given moment. The purpose of FIG. 12, though, is foremost to display the overlaid Heaviside step function of the high beam operation 506 as a function of ambient light 504. As the ambient light curve 504 meets a specified threshold 507, the Boolean switch is triggered to illuminate or extinguish the motorcycle high beam for the motorist. When the high beam is on, such as during the night or otherwise in poor atmospheric light conditions, it is on at its maximum intensity 512. When it is off, it is at zero intensity. The high beam being on or off is a factor which affects the subsequent headlight orientation directed by the microprocessor. In practice, the system may need to switch high beams on and off depending on other situations as well, such as dark tunnels. Therefore the system is configured collect ambient light data regularly, such as several times per second, or every few milliseconds, for example.

Referring to FIG. 13, there is shown another graph of the high beam function. This graph is an automatic dimming mode of the high beam operation 526, as a function of ambient light 520. A separate mode to the automatic on and off high beam operation uses automatic variable brightness of the high beam 526 during its analogue operation, in order to save energy. Dimmed lights may save energy proportionate to the amount dimmed from the maximum illumination setting, dependent on the engineering of the bulb or light source. Comparing FIGS. 12 and 13, the light in the dimmed ON setting, from dawn 528 for example, gradually shaves off in intensity and power compared to the Heaviside edge of the non-dimmed full ON dawn setting, as the ambient light intensifies toward midday 514, 534. Toward dusk 510, 530, a similar effect occurs. As the non-dimmed light turns full on toward dusk 510, the dimmed light gradually ramps up its intensity, and consequently power, at that time. While the light sensing process and decision-making steps to switch on the high beam are similar to those of FIG. 12, there are a number of differences. The process involves gradual dimming and brightening, not abrupt on or off operations. Therefore the decision thresholds differ for slight illumination and diminishing of the headlight, as do the consequent actions of the microcontroller in the gradual light adjustments up and down. The number of adjustments increase since the incremental adjustments occur on a semi-continuous basis and not just twice every 24 hours or on entering and exiting a dark tunnel. Similar to FIG. 12, the automatic nature of the device adds safety and convenience factors to the riding of the motorcycle.

The analog control operates within the legal minimum 540 and maximum 542 requirements for the brightness of the headlights and satisfies these limits. The high beam first automatically turns on at its minimal brightness once it senses darker conditions, for example at threshold 527. The high beam proceeds to get brighter as the night rolls in. It then dims the brightness once the environment becomes lighter at dawn 528, and turns off in well-lit conditions, such as midday 534.

The graph again displays the same simplified textbook example of light fluctuations throughout the day as an ambient light curve 524, as in FIG. 12. The level of atmospheric light based on the time of day, ranging from dawn 528 to dusk 530, is still an approximation for real world conditions, which may be different as real world light conditions are actually detected by the sensors at any given moment. In this graph, however, the high beam operation 526 is also fluid and smoothed, in a generally opposite sense to the ambient light curve 524. The lighting again reaches a maximum 542 shown by the dashed line, and also reaches zero, like the ON/OFF mode of the high beam. The high beam intensity is a factor which affects the subsequent headlight orientation directed by the microprocessor. The system is configured to collect ambient light data regularly, such as several times per second, or every few milliseconds, for example, which allows for rapid operation or adjustment of the headlights upon entering and exiting a dark tunnel.

### C. Variations

While this disclosed system has been described for use in motorcycles, any two-wheeled mode of transportation (i.e. scooters, bicycles) as well as 4-wheeled cars with a lean (i.e. rally cars) may benefit as well.

The system can also be used in watercraft, where fixed beam headlights sway with the boat during any pitch, roll or yaw movement on the water. Therefore, the use of adaptive headlights are beneficial to illuminate the watercraft's intended direction of travel.

The headlight tilt vs throttle or brake input trend may be linear or non-linear, provided that the beam is maintained in a level orientation on a flat road or aligned with a gradient of a sloping road, just like when the motorcycle is stationary and upright on the level.

If there are two or more headlights, each individual headlight may rotate independently from the other. For example, when riding down a straight road with the high beams turned on, and there is oncoming traffic on the left, the left headlight may rotate around the z axis and point to the right to avoid blinding the oncoming traffic. Since the right headlight remains pointed in the direction of travel, the road ahead continues to be illuminated.

Certain motorbikes have the headlights fixed to the body or fairings (i.e. sport bikes), and others have headlights that move with the handlebars (i.e. naked bikes). In the case of a headlight fixed to the body, the IMU is in the body. In the case of a headlight fixed to the handlebars, the IMU is still located in the body since it needs to detect forces of the whole bike, but a handlebar angle sensor is used in addition.

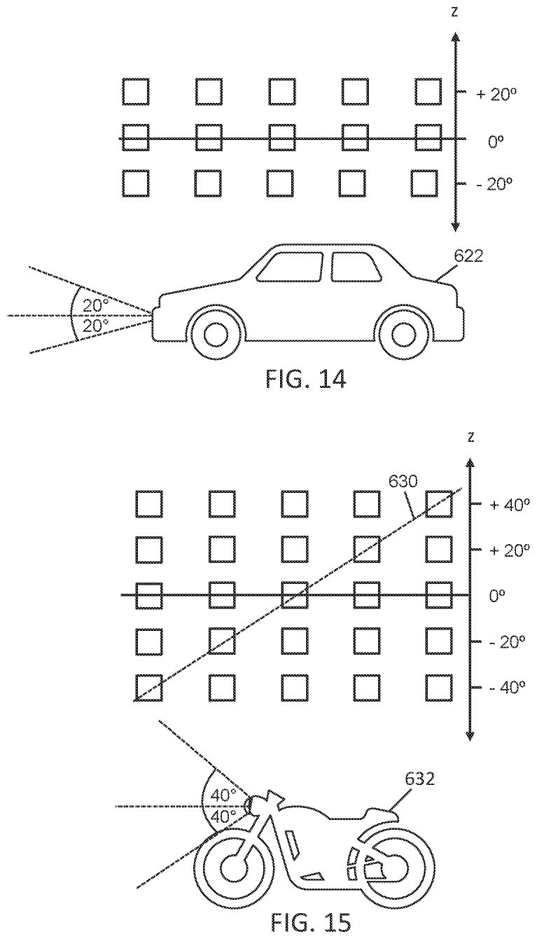

Referring to FIG. 14, there is shown a schematic of a stationary adaptive headlight made with an array of individual LEDs. In this example, the vehicle is a car. The car 622 has LED technology that needs to project a vertical light sweep up and down over an approximate 20 degree angle in both directions. It uses three levels of LEDs, for example, with aiming directions set in 20 degree increments relative to the car, to provide the light ahead toward the road.

A motorcycle matrix is more demanding than LED matrices for cars since it needs to accommodate tilt angle 630 through the corners. In FIG. 15, there is a more “square” matrix (more height) for a motorcycle headlight than a car headlight, in order to adjust the light upwards and downwards during tilting forward and backward of the motorcycle or while leaning. The LED-matrix adaptable headlight in motorcycle 632 is capable of projecting a vertical light sweep above and below horizontal, that extends over an approximate 40 degree angle up and down. It uses, for example, five rows of LEDs, aimed in 20 degree increments relative to the motorcycle, to provide the necessary range of light. The angles depicted for the car and motorcycle are not specifically chosen but are for demonstration purposes. In other embodiments, there are different numbers of row and/or columns in the array, and the arrays are not necessarily rectangular or regular.

A large, generally square matrix on its own requires larger heatsinks to cool the LEDs from the higher demand in light intensity compared to a shallow matrix for use in a car. A motorcycle headlight has smaller space constraints than a car, and therefore in some embodiments it not may not be desirable to fit a large matrix with large heatsinks. In some motorcycles, it also may not be desirable to use a rotating headlight mechanism with three degrees of freedom. In some embodiments, a hybrid combination of a smaller LED matrix and a two DOF rotating mechanism is used. By configuring the matrix to adjust the direction of light around one axis, it eliminates the need for mechanical rotation around that axis. This reduces the number of motors and platforms and thus reduces the size of the rotating mechanism. For example, for a matrix that controls illumination around the z axis, sweeping the LED illumination from left to right, then the rotating mechanism only needs to take care of rotation around the x and y axes. In another embodiment, a single motor is used to move the headlight about one axis, and adaptive control of an LED array is used to provide the direction of the beam in the other two axes.

In other embodiments, stepper motors may be used instead of the motors. Linear actuators may also be used. Stepper motor or actuator position may be encoded. In some embodiments, only the roll is compensated. As such only one motor or one DOF of beam adjustment is employed. Analytic functions may be used instead of look-up tables for one or more of the settings of the headlight angle.

In some embodiments, the adjustment of the headlight tilt for the slope of the road may be anticipatory, based on motorcycle location as detected by a GPS sensor and the topology stored in a map of the road. If the motorcycle is approaching a large or steep hill, the system adjusts the tilt of the headlight upward, to illuminate more of the road than would normally be illuminated. Likewise, if the motorcycle is approaching a long descent that gradually increases in its angle of slope, then the headlight is tilted downwards to illuminate more of the slope.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. In general, unless otherwise indicated, singular elements may be in the plural and vice versa with no loss of generality. Accordingly, the specification is to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware, firmware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

It will be clear to one having skill in the art that further variations to the specific details disclosed herein can be made, resulting in other embodiments that are within the scope of the invention disclosed. Two or more steps in the flowcharts may be performed in a different order, other steps may be added, or one or more may be removed without altering the main function of the invention. Modules may be divided into constituent modules or combined into larger modules. All parameters, dimensions, angles, components and configurations described herein are examples only and actual ones of such depend on the specific embodiment. Rotation about the x, y or z axis may also be understood to be rotation about the x, y or z direction respectively. Accordingly, the scope of the invention is to be construed in accordance with the substance defined by the following claims.

1. A headlight system for a vehicle comprising:
a light source that produces a light beam;
one or more sensors that detect an orientation of the vehicle in three dimensions and a motion of the vehicle in the three dimensions; and
a controller that uses the orientation and the motion to adjust a direction of the light beam about three orthogonal axes relative to the vehicle so that a path of the vehicle in the three dimensions is illuminated.

2. The headlight system of claim 1, wherein:
the orientation includes a roll of the vehicle; and
the controller adjusts the direction of the light beam to compensate for the roll.

3. The headlight system of claim 1 comprising three motors, each of which adjusts the direction of the light beam about a different one of the orthogonal axes.

4. The headlight system of claim 1 comprising a light-emitting diode array that is controllable to adjust the direction of the light beam about the orthogonal axes.

5. The headlight system of claim 1 comprising:
a motor that adjusts the direction of the light beam about one of the orthogonal axes; and
a light-emitting diode array that is controllable to adjust the direction of the light beam about another one of the orthogonal axes.

6. The headlight system of claim 1, wherein the light beam is a fixed-intensity high beam, an automatically dimmable high beam, a low beam, or a combination of a high beam and a low beam.

7. The headlight system of claim 1 comprising another sensor that detects oncoming traffic, wherein the controller further adjusts the light beam to reduce a chance of blinding a driver of the oncoming traffic.

8. The headlight system of claim 1 comprising another sensor that detects an angle of handlebars of the vehicle relative to the vehicle, wherein the controller adjusts the light beam by taking into account the angle.

9. The headlight system of claim 1, mounted in the vehicle, wherein the vehicle is a motorcycle.

10. A motorcycle having a headlight system comprising:
a light source that produces a light beam;
one or more sensors that detect an orientation of the motorcycle in three dimensions and a motion of the motorcycle in the three dimensions; and
a controller that uses the orientation and the motion to adjust a direction of the light beam about three orthogonal axes relative to the motorcycle so that a path of the motorcycle in the three dimensions is illuminated.

11. The motorcycle of claim 10 comprising another headlight system that is controlled independently from the headlight system.

12. The motorcycle of claim 10, wherein the sensors include an inertial measurement unit, a wheel speed sensor, a throttle sensor, a brake pressure sensor, a camera, a global positioning system (GPS) sensor or any selection therefrom.

13. The motorcycle of claim 12, wherein the sensors further include an ambient light sensor and the controller is configured to:
detect oncoming traffic; and
adjust the light beam to reduce a chance of blinding a driver of the oncoming traffic depending on an ambient light level detected by the ambient light sensor and the orientation of the motorcycle.

14. The motorcycle of claim 10 comprising three motors, each of which adjusts the direction of the light beam about a different one of the orthogonal axes.

15. The motorcycle of claim 10 comprising a light-emitting diode array that is controllable to adjust the direction of the light beam about the orthogonal axes.

16. The motorcycle of claim 10 comprising:
a motor that adjusts the direction of the light beam about one of the orthogonal axes; and
a light-emitting diode array that is controllable to adjust the direction of the light beam about another one of the orthogonal axes.

17. The motorcycle of claim 10, wherein:
the light source rotates with handlebars of the motorcycle;
the motorcycle further comprises a handlebar angle sensor; and
the controller uses the handlebar angle to adjust the direction of the light beam.

18. A method of controlling a headlight of a vehicle comprising:
producing a light beam with the headlight;
detecting, using one or more sensors, an orientation of the vehicle in three dimensions;
detecting, using the one or more sensors, a motion of the vehicle in the three dimensions; and
adjusting, by a controller that uses the orientation and the motion, a direction of the light beam about three orthogonal axes relative to the vehicle so that a path of the vehicle in the three dimensions is illuminated.

19. The method of claim 18, wherein:
detecting the orientation includes detecting a roll of the vehicle; and
adjusting the direction of the light beam includes compensating for the roll.

20. The method of claim 18, comprising:
detecting, using another sensor, oncoming traffic; and
adjusting, by the controller, the light beam to reduce a chance of blinding a driver of the oncoming traffic.

21. The method of claim 18, wherein the headlight rotates with handlebars of the vehicle and the method comprises:
detecting, using another sensor, an angle of the handlebars relative to the vehicle; and
adjusting, by the controller, the light beam to account for the angle.

22. The method of claim 18, wherein:
the motion of the vehicle includes an angle of a slope upon which the vehicle is traveling;
the orientation includes a pitch of the vehicle relative to the slope; and
the controller adjusts the direction of the light beam using the pitch of the vehicle relative to the slope.

23. The method of claim 18, wherein the controller adjusts the direction of the light beam to account for a slope that the motorcycle is traveling toward.
